(19) United States
(12) Patent Application Publication
(10) Pub. No.: US 2003/0085200 A1
(43) Pub. Date: May 8, 2003

(54) Device and method for securing bellows and bellows vapor shield to stem prior to brazing

(75) Inventors: Benjamin A. Rosenkrans, Elmira, NY (US); Kal L. Harrington, Painted Post, NY (US); Robert J. Hawthorne, Sayre, PA (US); Dale L. Burmingham, Ithaca, NY (US); Adam R. Taft, Pine City, NY (US)

Correspondence Address: Martin J. Moran, Esquire, Cutler-Hammer, Technology & Quality Center, 170 Industry Drive, RIDC Park West, Pittsburgh, PA, 15275-1032, US

(73) Assignee: Eaton Corporation, Cleveland, OH

(21) Appl. No.: 10/015,799

(22) Filed: Nov. 2, 2001

(51) Int. Cl. H01H 3/00

(52) U.S. Cl. 218/154

(57) ABSTRACT

A retaining ring is provided for holding a bellows and a vapor shield on a stem of a vacuum circuit breaker prior to brazing. The retaining ring includes a ring shaped body defining an opening. The body has a plurality of tabs that extend into the opening. The body has an inner diameter larger than the stem while the area defined by the tabs has a diameter that is about the same size as, or smaller than, said stem nominal diameter. The body and tabs are made from a harder material than the stem. In use, the shield and bellows are placed on the stem and brought to rest on a ledge. The retaining ring is then placed on the stem. As the retaining ring is placed on the stem, one or more of the tabs will flex and bend, slightly, away from the shield and bellows. The retaining ring is then slid down the stem until the retaining ring contacts the shield and/or bellows. Because the retaining ring is made from a harder metal that the stem, an attempt to remove the retaining ring will result in the flexed tabs digging into the stem. As such, once it is installed, the retaining ring cannot be removed by sliding the retaining ring backward on the stem. The retaining ring will hold the shield and bellows in place until the brazing process is complete.

### BACKGROUND OF THE INVENTION

1. Field of the Invention

This invention relates to vacuum interrupters and, more specifically, to a method for coupling the bellows and the bellows vapor shield of the vacuum chamber to the contact stem.

2. Background Information

Circuit breakers provide protection for electrical systems from electrical fault conditions such as current overloads, short circuits, and low level voltage conditions. Typically, circuit breakers include a spring-powered operating mechanism which opens electrical contacts to interrupt the current through the conductors in an electrical system in response to abnormal conditions. In particular, vacuum circuit interrupters include separable main contacts disposed within an insulated and hermetically sealed vacuum chamber within a housing. Generally, one of the contacts is fixed relative to both the housing and to an external electrical conductor which is interconnected with the circuit to be protected by the circuit interrupter. The other contact is moveable. In the case of a vacuum circuit interrupter, the moveable contact assembly usually comprises a copper stem of circular cross-section having the contact at one end enclosed within the vacuum chamber, and a driving mechanism at the other end which is external to the vacuum chamber.

The stem is typically coupled to a sealed bellows which maintains the vacuum environment within the chamber while enabling movement of the stem and thus the moveable contact. When electricity is flowing through the closed contacts and the contacts separate, an electrical arc is formed. The arc will vaporize a small amount of metal in the contact. To protect the bellows from the vaporized metal, a vapor shield is disposed between the contact and the bellows. The vapor shield and bellows each have a disk-like end cap and cylindrical side wall. The each end cap includes an opening sized to snugly fit about the stem. The stem includes a ledge upon which the shield and bellows rest. Both the bellows and the shield are coupled to the stem by brazing forming an airtight seal.

The prior art device and method of attaching the shield and bellows to the stem utilized a copper ring. That is, the shield and bellows were placed on the stem in contact with the ledge. The copper ring was then placed on the stem and brought into contact with the shield and/or bellows. The copper ring was then peened into place on the stem. Alternatively, a groove was cut into the stem and a snap ring placed in the groove coupled the shield and bellows to the stem. Once the shield and bellows were in place, the assembly was placed in a furnace for brazing.

Both of these devices and/or methods have disadvantages. The copper ring device/method requires that the copper ring be machined. The copper ring also presents a larger profile in the vacuum which can be a source of breakdown. The snap ring device/method requires that a groove be machined in the stem. Moreover, there is no guarantee that the snap ring will apply a constant force against the bellows and the shield. Both methods increase the amount of braze required to complete the joint. All these disadvantages increase the time and cost of making the joint.

There is, therefore, a need for a device and method for attaching a shield and bellows to stem that reduces the time and cost of coupling the shield and bellows to the stem.

There is a further need for a device and method for attaching a shield and bellows to stem that is compatible with existing equipment.

### SUMMARY OF THE INVENTION

These needs, and others, are met by the disclosed invention which provides a device and method utilizing a retaining ring. The retaining ring is made of a harder metal than the stem. An opening in the retaining ring is larger than the stem. The retaining ring further includes a plurality of tabs that extend into the opening. The inner diameter of the area defined by the tabs is sized to fit snugly about the stem.

To prepare the assembly for brazing, the vapor shield and bellows are placed on the stem and brought to rest on the ledge. The retaining ring is then placed on the stem. As the retaining ring is placed on the stem, one or more of the tabs will flex and bend, slightly, away from the shield and bellows. The retaining ring is then slid down the stem until the retaining ring contacts the shield and/or bellows. Because the retaining ring is made from a harder metal that the stem, an attempt to remove the retaining ring will result in the flexed tabs digging into the stem. As such, once it is installed, the retaining ring cannot be removed by sliding the retaining ring backward on the stem. The retaining ring will hold the vapor shield and bellows in place until the brazing process is complete. The retaining ring is smaller and less expensive than the prior art copper ring. The retaining ring does not require the stem to be machined. The retaining ring reduces the amount of braze required to complete the joint.

### BRIEF DESCRIPTION OF THE DRAWINGS

A full understanding of the invention can be gained from the following description of the preferred embodiments when read in conjunction with the accompanying drawings in which:

FIG. 1 is a side view of a vacuum circuit breaker.

FIG. 2 is a partial cut-away view of a vacuum chamber.

FIG. 3 is a cross-sectional side view of a portion of the vacuum chamber. FIG. 3A is a detail view of the stem ledge.

FIG. 4 is a plan view of the retaining ring.

FIG. 5 is a cross-sectional view of the installation tool, FIG. 5A is a detail view of the ring engaging end of the installation tool.

### DESCRIPTION OF THE PREFERRED EMBODIMENTS

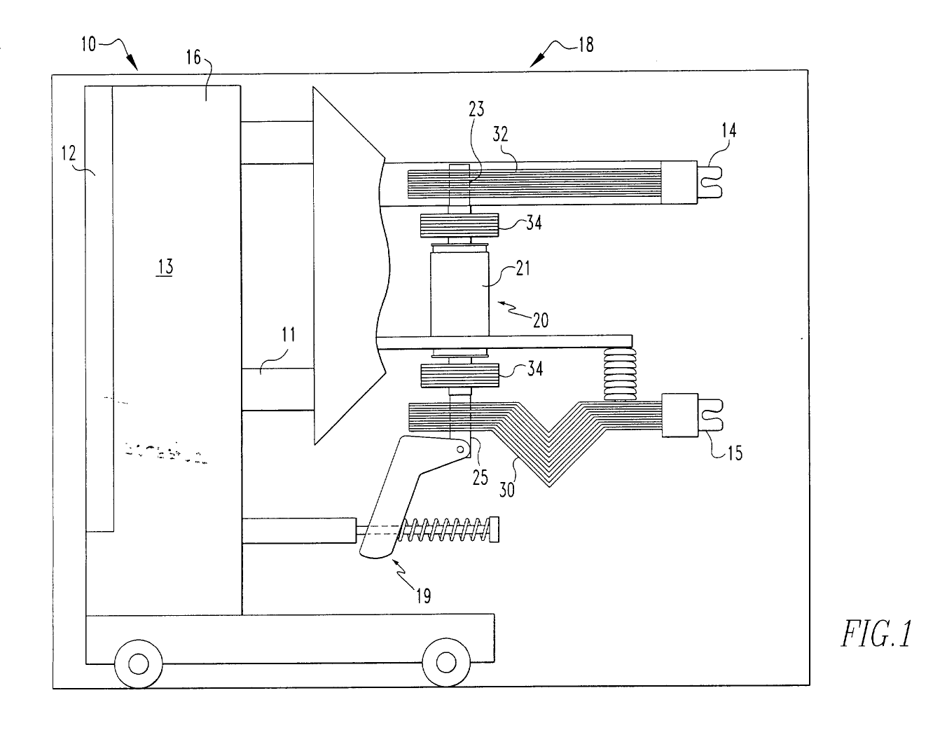

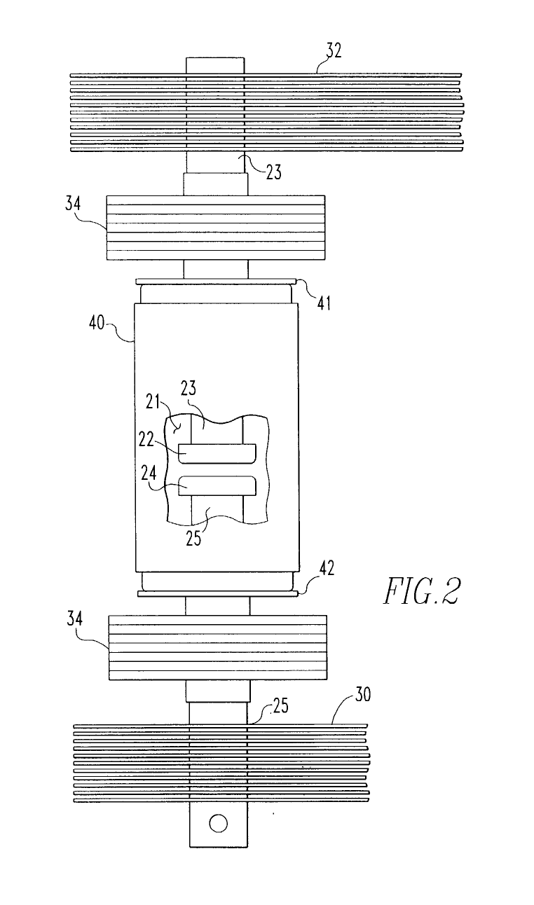

Referring to FIG. 1, there is illustrated a circuit breaker 10 incorporating a vacuum interrupt apparatus 20. The circuit breaker 10 preferably includes a front panel 12 which has controls for manually operating the circuit breaker 10 and changing the state of the contacts to either an open or closed condition and a circuit breaker housing 13. The circuit breaker has an upper and a lower terminal 14 and 15, and may have additional terminals not visible in FIG. 1, which can be connected to a line-in (not shown) and a load (not shown). The circuit breaker 10 has a low voltage portion 16 adjacent to the front panel 12 and a high voltage portion 18 including the vacuum interrupter assembly 20. The vacuum interrupter assembly 20 includes a vacuum chamber 21 which encloses a pair of separable contacts 22, 24 (FIG. 2).

Details about the operating mechanism 19 for moving the contacts 22 and 24 between an open and closed condition are described in detail in U.S. Pat. No. 4,743,876, which is owned by the assignee of the present application. U.S. Pat. No. 4,743,876 is herein incorporated by reference in its entirety. Generally, as shown in FIG. 2, the separable contacts 22, 24 include a fixed contact 22 mounted on the end of a fixed contact stem 23 and a movable contact 24 mounted on the end of a movable contact stem 25. The contact stems 23, 25 extend out of opposite ends of the vacuum chamber 21. The stems 23, 25 have a generally circular cross-sectional area with a nominal diameter. Typically, the stems 23, 25 are made of copper. The movable contact stem 25 is coupled to one end of a flexible conductor 30 which is connected at its opposite end to the load terminal 15. Preferably, the flexible conductor 30 is of the type described in U.S. Pat. No. 5,530,216 or of the type described in U.S. Pat. Nos. 4,376,235, or 4,384,179. Such flexible conductors 30 are constructed of a stack of thin flexible sheets of a conductive material such as copper. The fixed contact stem 23 is similarly coupled to a conductor 32 which connects it to the line terminal 14. Preferably, this conductor 32 is also constructed of a stack of conductive sheets. While this conductor need not be flexible, the spaced laminations provide good heat dissipation especially since the sheets are separated by spacers in between at each end. The operating mechanism 19 (FIG. 1) is actuated by components (not shown) in the low voltage section 16 of the circuit breaker raises and lowers the movable stem 25 to close and open the separable contacts 22, 24 as is well known. The stems 23, 25 may each be provided with a heat transfer device 34.

As shown in FIG. 2, the vacuum interrupter assembly 20 also includes a cylindrical insulating tube 40 which, in combination with the end seals 41 and 42, forms the vacuum chamber 21. The insulating tube 40 is preferably made of a ceramic material such as alumina, zirconia or other oxide ceramics. A bellows 44 and vapor shield 46 are coupled to the stem 25 of the movable contact 24.

The bellows 44 and the vapor shield 46 each include an opening through which the stem 25 passes. That is, the openings in the bellows 44 and the vapor shield 46 are sized to allow the stem 25 nominal diameter to pass therethrough. The stem 25 further includes a ledge 28 which has a diameter that is larger than the openings in the bellows 44 and the vapor shield 46 as well as the nominal diameter of the stem 25. As such, as shown in FIG. 3A, the bellows 44 and the vapor shield 46 contact the ledge 28. As detailed below, the bellows 44 and the vapor shield 46 are coupled to the stem 25 by brazing.

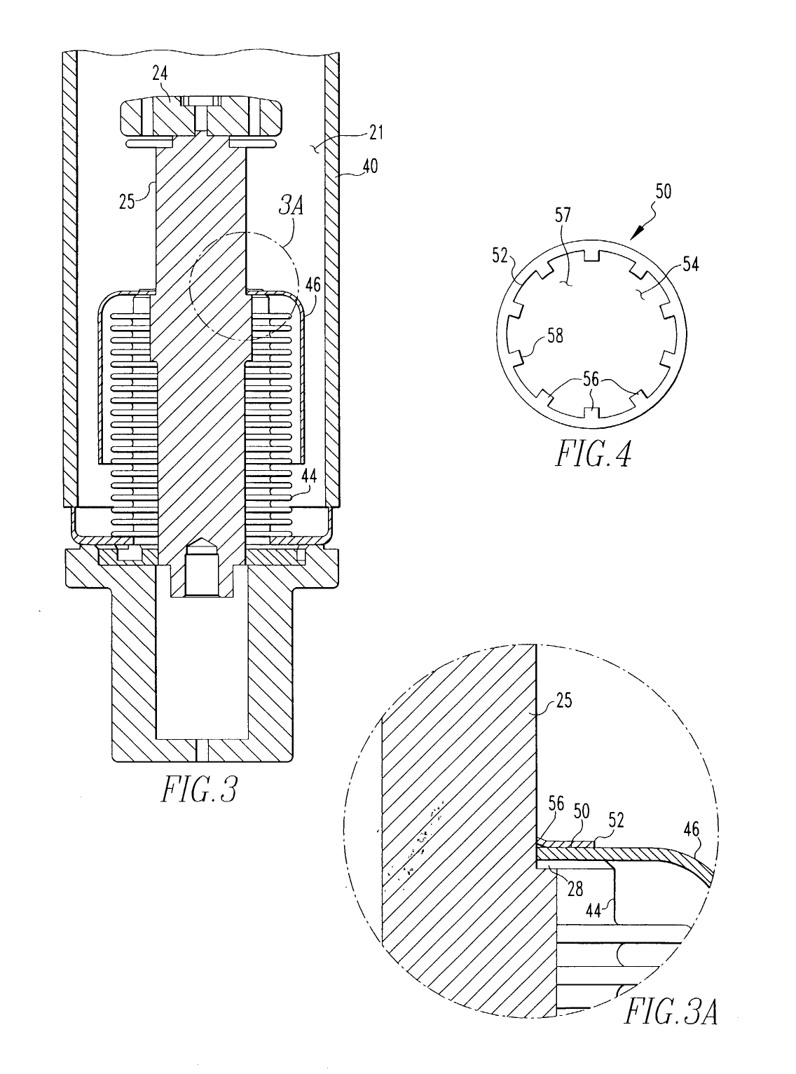

The retaining ring 50, shown in FIGS. 3, 3A, and 4, is used to hold the bellows 44 and the vapor shield 46 in place during the manufacture of the assembly. The retaining ring 50 includes a ring shaped body 52 defining an opening 54 and a plurality of tabs 56. The opening 54 is sized to have an inner diameter that is larger than the stem 25 outer diameter. The plurality of tabs 56 define an area 57 having a diameter that is about the same size as, or slightly smaller than, the stem 25 nominal diameter. The retaining ring 50 is made from carbon steel or stainless steel. There are typically between six and ten tabs 56, and preferably ten tabs 56, extending into the opening 54. The distal end of each tab 56 preferably has a sharp edge 58. That is, the distal edge is not rounded. The sharp edge 58 may be the corner formed by a stamping process during the manufacture of the retaining ring 50.

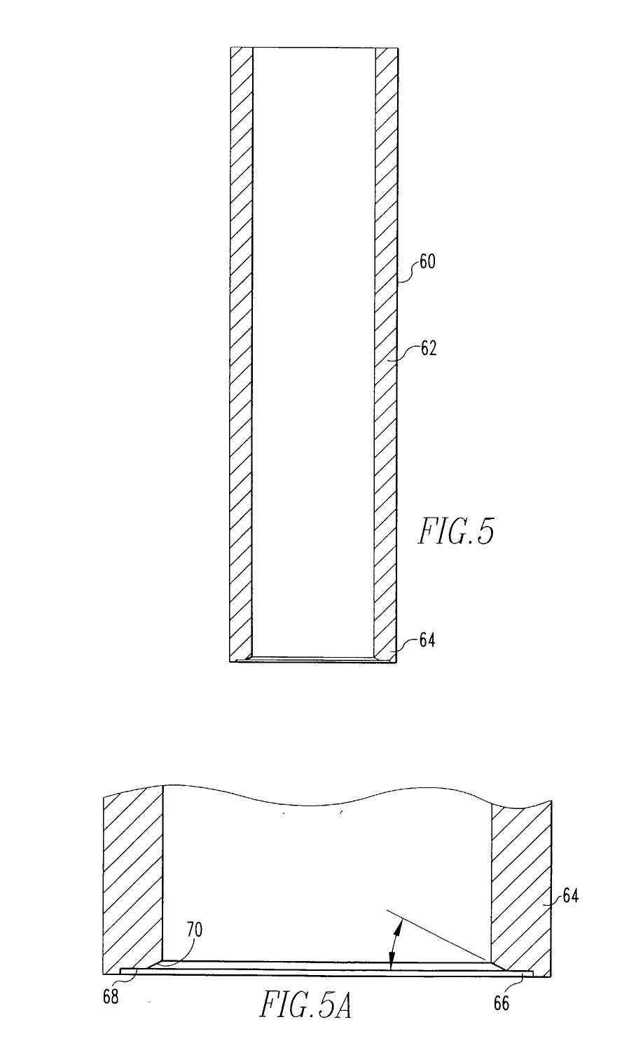

The retaining ring 50 is installed using an installation tool 60, as shown in FIG. 5. The installation tool 60 has a hollow cylindrical body 62. The inner diameter of the installation tool body 62 is about the same size as, or slightly larger than, the nominal diameter of the stem 25. The outer diameter of the installation tool body 62 is larger than the outer diameter of the retaining ring 50. The installation tool 60 also includes a ring engaging end 64. The ring engaging end 64 includes a recess 66 sized to accommodate the retaining ring 50. The recess 66 includes a generally flat portion 68 and a beveled portion 70. The flat portion 68 is sized to accommodate the ring shaped body 52. The beveled portion 70 is structured to engage the tabs 56 and allow the tabs 56 to bend. The angled portion 70 is angled between about 20 to 30 degrees, and preferably 25 degrees, from the flat portion 68.

To couple the bellows 44 and vapor shield 46 to the stem 25, the following method is used. The stem 25, with a ledge 28, is provided without the contact 24, shown in FIG. 3, attached. The stem 25 is passed through the openings in the bellows 44 and the vapor shield 46. The bellows 44 and the vapor shield 46 are brought into contact with the ledge 28. The retaining ring 50 is then placed on the stem 25. As the retaining ring 50 is placed on the stem 25, one or more of the tabs 56 will flex and bend, slightly, away from the vapor shield 46 and bellows 44, as shown on FIG. 3A . Then, using the installation tool 60 the retaining ring 50 is moved down the stem 25 until the retaining ring 50 contacts the vapor shield 46 and/or bellows 44. That is, the installation tool 60 is placed over the stem 25 so that the stem 25 is within the hollow cylindrical body 62. The ring shaped body 52 is disposed within the flat portion 68 of the recess 66 and the flexed tabs 56 engage the beveled portion 70. The installation tool 60 is used to slide the retaining ring 50 into contact with the vapor shield 46 and bellows 44.

Because the retaining ring 50 is made from a harder metal that the stem 25, an attempt to remove the retaining ring 50 will result in the flexed tabs 56 digging into the stem 25. As such, once it is installed, the retaining ring 50 cannot be removed by sliding the retaining ring 50 backward on the stem 25. The retaining ring 50 will hold the vapor shield 46 and bellows 44 in place until the brazing process is complete. The vapor shield 46 and bellows 44 are then coupled to the stem 25 by a brazing process as is well known in the prior art. After the brazing operation the braze as well as the retaining ring 50 secures the vapor shield 46 and bellows 44 to the stem 25.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A retaining ring for securing a bellows and a vapor shield to a copper stem of a vacuum circuit breaker, said stem having a nominal diameter, said retaining ring comprising:
a ring shaped body defining a central opening;
a plurality of tabs extending into said opening and defining an area;
said body having an inner diameter larger than said stem;
said area having a diameter that is about the same size as, or smaller than, said stem nominal diameter.

2. The retaining ring of claim 1 wherein each said tab has a distal end with a sharp edge.

3. The retaining ring of claim 1 wherein said plurality of tabs comprises between six and ten tabs.

4. The retaining ring of claim 1 wherein said plurality of tabs comprises ten tabs.

5. The retaining ring of claim 1 wherein said body and tabs are made from a metal that is harder than said stem.

6. The retaining ring of claim 1 wherein said body and tabs are made from a metal selected from the group consisting of carbon steel and stainless steel.

7. A vacuum circuit breaker comprising:
a sealed vacuum chamber;
a first stationary contact sealed within the vacuum chamber;
a stationary contact stem coupled to said stationary contact;
said stationary contact stem sealably penetrating the vacuum chamber and coupled to a first electrical connector;
a moveable contact sealed within the vacuum chamber and moveable between a first position, out of electrical communication with the first stationary contact, and a second position, in electrical communication with the stationary contact;
a movable copper contact stem, having a nominal diameter and a ledge, coupled to said movable contact;
said movable contact stem sealably penetrating the vacuum chamber and coupled to a first electrical connector;
means coupled to said movable contact stem for moving the moveable contact between the first and second positions in response to an actuation command;
a bellows;
a vapor shield;
said movable contact stem coupled to said bellows and said vapor shield;
a retaining ring supporting said bellows and said vapor shield;
said retaining ring comprising:
a ring shaped body defining a central opening;
a plurality of tabs extending into said opening and defining an area;
said body having an inner diameter larger than said stem;
said area having a diameter that is about the same size as, or smaller than, said stem nominal diameter.

8. The vacuum circuit breaker of claim 7 wherein each said tab has a distal end with a sharp edge.

9. The vacuum circuit breaker of claim 7 wherein said plurality of tabs comprises between six and ten tabs.

10. The vacuum circuit breaker of claim 7 wherein said plurality of tabs comprises ten tabs.

11. The vacuum circuit breaker of claim 7 wherein said body and tabs are made from a metal that is harder than said stem.

12. A method of securing a bellows and a vapor shield on a stem of a vacuum circuit breaker comprising the following steps:
a) providing a vacuum circuit breaker stem having a nominal diameter and a ledge having a diameter larger than said nominal diameter;
b) providing a bellows with an opening sized to allow said stem nominal diameter to pass therethrough;
c) providing a vapor shield with an opening sized to allow said stem nominal diameter to pass therethrough;
d) providing a retaining ring having a ring shaped body defining an opening, said body having an inner diameter that is larger than said stem nominal diameter, and a plurality of tabs extending into said opening, said tabs defining an area that is the same size, or smaller than, said stem nominal diameter;
e) placing said bellows and said vapor shield on said stem by passing said stem nominal diameter portion through said bellows opening and said vapor shield opening;
f) moving said bellows and said vapor shield into contact with said ledge;
g) placing said retaining ring on said stem by passing said stem nominal diameter portion through said retaining ring opening;
h) moving said retaining ring into contact with said bellows or vapor shield thereby holding said bellows and vapor shield against said ledge;
i) brazing said bellows and said vapor shield to said stem.

13. The method of claim 12 further comprising the step of allowing some of the tabs to flex in a direction away from the bellows and vapor shield.

14. The method of claim 12 wherein said stem is made from copper and retaining ring is made from a metal selected from the group consisting of carbon steel and stainless steel.

15 The method of claim 12 wherein each said tab has a distal sharp edge.

16. The method of claim 12 comprising the further steps of:
a) providing an installation tool having a hollow cylindrical body, said body structured to fit over said stem and having a ring engaging end with a recess;
b) using said installation tool to move said retaining ring into contact with said bellows or vapor shield.

17. The method of claim 16 wherein said installation tool recess has a flat portion and a beveled portion, said beveled portion structured to engage said tabs.
